(19) United States
(12) Patent Application Publication
(10) Pub. No.: US 2026/0224425 A1
(43) Pub. Date: Aug. 6, 2026

(54) KNEE EXTENSION SYSTEMS AND RELATED METHODS

(71) Applicant: Sapphire G, LLC, Redondo Beach, CA (US)

(72) Inventors: Michael John LYLE, Chevy Chase, MD (US); William Randall MCFADDEN, Redondo Beach, CA (US)

(73) Assignee: Sapphire G, LLC, Redondo Beach, CA (US)

(21) Appl. No.: 19/530,272

(22) Filed: Feb. 4, 2026

Related U.S. Application Data
(60) Provisional application No. 63/753,822, filed on Feb. 4, 2025.

(51) Int. Cl. A61H 1/02

(52) U.S. Cl. CPC A61H 1/024; A61H 2201/0157; A61H 2201/1642; A61H 2201/168; A61H 2203/0437

(57) ABSTRACT

Passive knee extension systems and related methods of promoting knee extension. The system comprises a shell comprising a pliable base portion and a rigid top portion. The base portion comprises first and second ends, first and second lateral sides, a top side and an interior cavity. The system further comprises a first and second mounting straps extending between the first and second lateral sides proximate to the first and second ends, respectively. The system also comprises a rigid container with an open top positioned within the interior cavity, and a plurality of base weights positionable within exterior weight pockets of the first and second lateral sides. The system further comprises a compressible support cushion positionable on the top portion. The top portion is movable between a closed position extending over the top of the container, and an open position with the top of the container being exposed.

### CROSS-REFERECNE TO RELATED APPLICATION

This application perfects and claims priority benefit of U.S. Provisional Patent Application No. 63/753,822 filed on Feb. 4, 2025, the entire subject matter of which is hereby incorporated herein by reference.

### FIELD OF THE DISCLOSURE

The present disclosure relates to knee extension systems and related methods that promote, maintain and restore full knee extension. More specifically, but not exclusively, the present disclosure relates to knee extension systems and related methods that are configured to couple to a user's elevated leg to passively and/or actively promote, maintain and restore knee extension.

### BACKGROUND

Knee extension is the straightening of a leg of human at the knee joint, moving it from a bent (flexion) position to a straight, neutral position (0 degrees) or slightly beyond a neutral straight (hyperextension) (e.g., about 1.5 degrees straight). Primarily driven by the quadriceps muscles, knee extension movement is essential for walking, running, jumping, and standing. For example, proper knee extension is crucial for standing tall, pushing off while walking, and supporting body weight, proper weight distribution, reducing energy expenditure and preventing injury to the hips, back, and ankles. For example, a normal walking gait requires the knees to completely straighten (i.e., achieve full extension). Proper and/or full knee extension is essential for strengthening the quadriceps, reducing pain/swelling, and preventing long-term stiffness of a person's knee. The main muscles involved in knee extension are the quadriceps femoris, but other muscles, ligaments and soft tissues, and the knee joint itself, also play a role.

There are a variety of issues that could negatively affect a person's knee extension, such as negatively affect their range of knee extension, ease of knee extension, pain-free knee extension, smoothness of knee extension, etc. Regaining proper or improved knee extension once knee extension has been has been deteriorated (for any reason) is often prioritized over flexion to prevent permanent stiffness and scar tissue buildup, for example. If knee stiffness is not addressed in the very early stages of rehabilitation, it can have a detrimental effect on quality of life and rehabilitation timeframes and ultimate outcomes.

For example, when a patient has a knee surgery, such as knee replacement, arthroscopy or ligament repair or reconstruction (e.g., anterior cruciate ligament (ACL), medial collateral ligament (MCL), lateral collateral ligament (LCL), meniscus and/or patella tendon repair or reconstruction), or suffers from osteoarthritis of the knee, it is critical for the patient to recover full range of knee extension which can be restricted by scar formation, (muscle) contractures, inflammation, restrictive and/or constricted ligament(s) and/or muscle, or inadequate rehabilitation. It is noted that disease, trauma or other injuries can likewise deteriorate or limit knee extension. Achieving a fully straighten the knee joint is crucial for knee joint health, reducing knee pain, and ensuring proper knee bending and knee flexion. When patients can straighten an operated knee fully, they reduce strain on surrounding structures, particularly the quadriceps and kneecap, and prevent compensatory movement patterns that could lead to further issues.

Inadequate knee extension may cause pain and lead to an abnormal gait due to uneven weight distribution. In some situations, inadequate knee extension can result in and/or from scar tissue formation at the back of the knee, which can lead to chronic stiffness. Many patients with inadequate knee extension experience reduced overall mobility, which leads to dysfunction in other joints.

Accordingly, restoring full range of motion soon after it is compromised, such as but not limited to after disease, degeneration, total knee replacement (TKR) or other knee replacement, repair or reconstruction procedures, has significant benefits, including reduced pain and swelling, improved muscle strength, faster recovery, and successfully regaining full knee extension.

Typical methods for improving knee extension, such as to assist with knee extension pain management, and to improve knee extension mobility and function, include isometric exercises, such as passive and active range of motion, strengthening and stretching exercises. These exercises can be done initially in the presence of a physical therapist or practitioner to monitor the patient's tolerance and performance, and then advised to be performed independently at home to promote carryover. Exercise programs are often given to patients in order to improve knee extension. A main component of compliance with a knee extension exercise programs is ease of use and access to equipment. Compliance with a knee extension exercise program is essential to achieve the desired clinical outcome. Physical therapists, practitioners and the patient's themselves are critical to supporting and achieving full knee extension through knee extension exercise programs.

Current knee extension system and devices are clunky/cumbersome, uncomfortable, difficult to manipulate/adjust, and difficult to use independently. For example, current knee extension therapeutic devices include strapping the user's leg to a stiff board, and mechanical knee braces with fixed position advancement.

Accordingly, improved knee extension systems, devices and related methods that effectively promote, maintain and restore full knee extension are needed. For example, knee extension systems and devices (and related methods) that are comfortable, safe, effective and configured for use by a user without assistance are desirable. Further, knee extension systems and devices (and related methods) that allow users to easily engage and use the system/device while avoiding pain or discomfort, would be beneficial. Still further, knee extension systems and devices (and related methods) that provide for both passive and active knee extension, and/or that achieve rapid and long-term improved knee extension clinical outcomes are needed. For example, knee extension systems and devices (and related methods) improve knee extension range of motion, reduce stiffness and swelling, and reduce pain, while being able to be used by a user at home or in a therapeutic setting, are desirable.

### SUMMARY

Aspects of the present invention provide systems, devices, components and related methods for passively and/or actively promoting, maintaining and restoring knee extension. The systems, devices, components and related methods overcome the shortcomings of prior knee extension systems, devices, components and related methods. The systems, devices, components and related methods of the present disclosure provide improved knee extension systems, devices, components and related methods that are comfortable, safe, effective and configured for use by a user without assistance. The systems, devices and related methods of the present disclosure allow users to easily engage and use the system/device while avoiding pain or discomfort. The systems, devices, components and related methods of the present disclosure also provide for both passive and active knee extension, and achieve rapid and long-term improved knee extension clinical outcomes. The systems, devices, components and related methods of the present disclosure improve knee extension range of motion, reduce stiffness and swelling, and reduce pain, while being able to be used by a user at home or in a therapeutic setting.

The systems, devices, components and related methods of the present disclosure provide for improved knee extension range of motion, strength, and flexibility of the knee joint in rehabilitation. The systems and devices are portable, can be used by a user by themselves (e.g., in a seated or prone position), and provide controlled extension of the knee joint using an applied, controlled force through weight suspension below the knee to progressively achieve full knee and leg extension.

The knee extension systems, devices, components and related methods of the present disclosure are therapeutic systems, devices, components and related methods that can be combined with other passive and active range of motion techniques, that facilitate knee extension long-term range of motion gains safely and comfortably. The knee extension systems, devices, components and related methods provide for self-reliant, graduating knee extension forces to improve knee extension following surgery, injury or disease. The knee extension systems, devices, components and related methods utilize a symmetric gravity-based (passive) graduating weight system for improving range of knee motion and extension.

The knee extension systems, devices, components and related methods are specifically designed for easily engaging a leg/knee area of a user with very little pain or discomfort. The knee extension systems and devices, and related methods, utilize a number of components and design features, each with specific benefits, that operate in cooperation to couple or suspend a weight-based system from sides of a user's knee. The weight-based system incudes selectable weights to provide a variety of passive (gravity-based) user-selectable knee extension forces, and also provides for simultaneous active knee extension forces or exercises if desired.

In some embodiments, the weight-based knee extension systems and devices, and related methods of use thereof, include a plurality of base weights that are selectively carried by a therapeutic weight case or shell that couples to a leg of a user to provide passive knee extension. The therapeutic weight case/shell contains an inner cavity with a rigid container contained therein, a rigid lid/cover/top, and a pair of comfort mounting straps (with may include double cinch adjustments) for extending over a user's leg on sides of a knee. The system also comprises a weight pocket system formed of a plurality of individual base weights and a plurality of weight pockets on the therapeutic weight case/shell configured such that the base weights can be individually and manually positioned in or removed from the pockets to customize the weight of the system, and thereby the passive knee extension force exerted by the system during use. Additional weight may be added by the user to into the rigid container to selectively increase the passive knee extension force.

The knee extension systems and devices, and related methods of use thereof, also include a support cushion or pillow, such as a foam cushion or pillow, that is positionable on the rigid top, and the rigid top is positionable on a top rim or periphery of the rigid container. In such an arrangement, the mounting straps may be adjusted (e.g., shortened) such that the support cushion engages the posterior side of the knee of the user, and the user can actively extend their knee to force the posterior side of the knee against the support cushion (and the rigid top (and the rigid container) (which may thereby compress the support cushion) to provide for active knee extension.

In some embodiments, the therapeutic weight case may be longer than it is wide (e.g., at least about 8 inches long, such as about 10 or about 12 inches long), although other configurations may be utilized. The therapeutic weight case and the mounting straps may be configured such that the mounting straps are positioned on opposite sides of a knee of a user in use, such as past incisions or other areas of discomfort on/about the knee. The mounting straps may be mounted or removably coupled with the therapeutic weight case/shell, such as via release buckle clips or like coupling mechanisms. The system may be configured such that when each mounting straps is coupled with the therapeutic weight case/shell and extends over a user's leg extended and supported leg, the mounting straps are spaced at least about 2 or about 3 inches above and below the average sized user's knee. The mounting straps may include padding or cushioning, which may be slidable or movable along the length of the mounting straps, to provide comfort against the top of the user's leg. In use, one mounting strap may be positioned over a distal portion of the user's thigh, and the other mounting strap may be positioned over a proximal portion of the user's shin. In some embodiments, the mounting straps may include cinch straps, buckles or strap adjuster or adjustment mechanism that allows for the lengthening and shortening of the length of the mounting straps (e.g., via adjustment of the pathway of the strap through the buckle, strap adjuster or other adjustment mechanism), which may be utilized to pulling the support cushion (via the rigid top, rigid container and the therapeutic weight case/shell itself) up against the back/posterior side of the user's leg and/or knee.

In some embodiments, the rigid top may be a lid of the therapeutic weight case/shell that fully covers the top of the therapeutic weight case/shell, the inner cavity thereof, and the rigid container within the inner cavity (and the open top or outer top rim of the rigid container) in a closed arrangement of the lid with respect to the therapeutic weight case/shell. A peripheral portion of the rigid top and corresponding peripheral portion of the top side of the therapeutic weight case/shell may include a zipper or other coupling mechanism or device to removably couple, seal or interlock them together. In some embodiments, the therapeutic weight case/shell may be flexible or pliable, such as being formed of a fabric, cloth, vinyl sheet or like material(s), and the top portion may include a pliable outer covering (e.g., fabric covering) and a rigid insert, core or member. In some embodiments, the rigid container may be an open topped (e.g., plastic container) that includes a top lip, rim or edge extending around an open top periphery. The top lip of the open top periphery of the rigid container provides a stable base or structure for the rigid lid to remain stiff against the downward pressure is applied thereto during knee extension, such as when the support cushion is positioned on the rigid lid pressed against the back/posterior side of the user's leg and/or knee and the knee is extended. The rigid container, and the therapeutic weight case/shell and the rigid top portion, are configured to provide static resistance against a downward force of a knee in extension (i.e., while extending) and/or flexion (i.e., while flexing).

As noted above, in some embodiments, the system may include at least two areas for carrying weight. The inside of the therapeutic weight case/shell, the open top rigid container is able to hold one or more weights or weighted objects. As the open top rigid container provides or forms an open unobstructed area or clear space, any weight or object can be placed inside at the onset of a therapeutic session or during a therapeutic session. For example, depending on where a user stands in their knee extension treatment or therapy, the rigid container may left empty, or a relatively medium weight (e.g., about 3 to about 6 pounds) can be placed into the rigid container, or a relatively heavy weight (e.g., about 5 to about 8 pounds) can be placed into the rigid container. In addition to the rigid container, the base weight pockets on the therapeutic weight case/shell (on the exterior thereof) can hold one or more of the base weights. For example, the therapeutic weight case/shell may include four weight pockets located on the outside of the therapeutic weight case/shell for holding four base weights. The pockets may be equally spaced along the length of the therapeutic weight case/shell, with two pockets on each lateral side of the therapeutic weight case/shell. The pockets of the therapeutic weight case/shell may or may not be used, or some of the pockets may be use. For example, during use or a treatment plan, weights, and then additional weights, may be gradually added to the pockets over time. For example, during a therapeutic session, the ability to add weight incrementally is can be used to maximize knee extension or stretch during the session.

In some embodiments, the base weights may be high density bars, such as coated steel bar, that fit within the base weight pockets of the therapeutic weight case/shell. In some exemplary embodiments, each base weights may be the same weight (or they may comprise different weights), such as each base weight weighing approximately 2 lbs. During use, one, two, three or all four of the base weights may be placed into the base weight pockets of the therapeutic weight case/shell into the pockets without removing the system from the user.

As noted above, the support cushion can provide cushioning against a posterior side (or anterior side) of a user's leg or knee. When positioned on the rigid top portion, the support cushion may assist in supporting a knee or leg in a certain limited degree of flexion, and configured with sufficient compression or resiliency such that the support cushion compresses to allow a knee to straighten/extend (i.e., move in extension) while using the device. Further, the support cushion may not be positioned on (or removed form) the rigid top portion, and instead be used to support a user's foot or ankle in an elevated, extended position.

The system thereby provides for a variety of differing knee extension therapeutic options or configurations. For example, the therapeutic weight case/shell can initially be used unweighted (no added weight), and then any combination or amount of weight can be added to the rigid container and/or the base weight pockets during use and/or over time. Also, the support cushion may be positioned on the rigid top portion to support a knee or leg of a user positioned over the therapeutic weight case/shell during use, or may not be used with the therapeutic weight case/shell, such as being used to support a support a user's foot or ankle in an elevated, extended position during use.

During use, the system is configured such that gradual pressure, force or weight is passively applied to a user's knee in such a manner that promotes knee extension. However, the system is configured is also configured such that the user can actively extend their knee against the support of the system on the underside/posterior side of the knee for active knee extension. In this way, the system provides for both static progressive knee extension/stretch under passive load, and active progressive knee extension/stretch via activation of the quadriceps muscle for active knee extension/stretch.

It is noted that the system may be used with the leg of the user at least partially extended or outstretched, and supported at their foot or ankle. The system may then be hung/suspended from the user's leg by placing the mounting straps above and below the knee, for example. Passive extension of the user's knee occurs when the user relaxes their leg muscles and allows the weight of the system (gravity) to do the work in pulling the system downwardly, thereby straightening/extending the knee/leg. If the support cushion is used, the support cushion can be positioned behind/under the user's knee (e.g., in partial flexion) to provide support during passive extension. As the user progresses, the support cushion can be removed allowing for greater extension. Further, the downward passive force/pressure can be gradually increased by placing additional base weights in the external pockets and/or weight into the container, as tolerated by the user. Active extension may occur when the user flexes their leg muscles (e.g., contracts their quadriceps muscle) into the rigid top portion/container and the support cushion to force the extension/straightening of the user's knee/leg. It is noted that even if the support cushion is not positioned on the rigid top portion, a user may still activate their leg muscles (e.g., contracts their quadriceps muscle) to provide active knee extension during a passive knee extension force applied by the system.

In one aspect, provided herein are knee extension systems (such as passive and/or active knee extension systems), comprising a shell, a first mounting strap, a second mounting strap, a container, a support cushion and a plurality of base weights. The shell comprises a pliable base portion and a rigid top portion. The base portion of the shell comprises a first end, a second end, a first lateral side extending between the first and second ends comprising a first plurality of exterior weight pockets, a second lateral side extending between the first and second ends comprising a second plurality of exterior weight pockets, a bottom side, a top side and an interior cavity. The first mounting strap extends between the first and second lateral sides proximate to the first end of the base portion of the shell, and the second mounting strap extends between the first and second lateral sides proximate to the second end of the base portion of the shell. The container is positioned within the interior cavity, and is rigid, hollow and comprises an open top. The support cushion is compressible and positionable on a top surface of the top portion of the shell. The plurality of base weights are individually positionable within the first and second plurality of exterior weight pockets of the base portion of the shell. The top portion of the shell is movable with respect to the base portion of the shell between a closed position wherein the top portion extends over the top side of the base portion and the top of the container, and an open position wherein at least a portion of the top portion is spaced from the top side of the base portion and the top of the container is exposed.

In some embodiments, the first mounting strap extends between the first and second lateral sides and over the top portion of the shell, and wherein the second mounting strap extends between the first and second lateral sides and over the top portion of the shell. In some embodiments, the first mounting strap is configured to extend over an anterior side of a distal portion of a user's thigh, and the second mounting strap is configured to extend over an anterior side of a proximal portion of the user's shin. In some such embodiments, the first mounting strap is a flexible, length-adjustable strap that comprises a first cushioned strap pad that is slidable along a length of the first strap, and the second mounting strap is a flexible, length-adjustable strap that comprises a second cushioned strap pad that is slidable along a length of the second strap. In some such embodiments, the first cushioned strap pad defines a width that is greater than a width of the strap of the first mounting strap, and the second cushioned strap pad defines a width that is greater than a width of the strap of the second mounting strap.

In some embodiments, the first mounting strap is removably coupled with a first portion of the first lateral side and removably coupled with a first portion of the second lateral side, and wherein the second mounting strap is removably coupled with a second portion of the first lateral side and removably coupled with a second portion of the second lateral side. In some such embodiments, the first plurality of exterior weight pockets are arranged between the first and second portions of the first lateral side, and the second plurality of exterior weight pockets are arranged between the first and second portions of the second lateral side. In some embodiments, the first plurality of exterior weight pockets define open top sides, and the second plurality of exterior weight pockets define open top sides.

In some embodiments, the plurality of base weights each a rubber coated steel bar. In some embodiments, the plurality of base weights each define a total weight within the range of 1 lb and 3 lbs.

In some embodiments, the compressible support cushion is positioned on the top surface of the top portion of the shell with the top portion in the closed position. In some embodiments, the support cushion defines a substantially flat bottom side that engages the top surface of the top portion and a convex top side that engages a posterior side of a knee.

In some embodiments, a first lateral side of the top portion and the first lateral side of the base portion at the top side of the base portion are coupled and form a living hinge such that the top portion is rotatable about the living hinge between the closed and open positions. In some such embodiments, a first end, a second lateral side and a second end of the top portion form a peripheral portion of the top portion, and the first end, the second lateral side and the second end of the top portion is configured to be removably coupled with the first end, the second lateral side and the second end of the base portion, respectively, at the top side of the base portion in the closed position of the top portion. In some such embodiments, the first end, the second lateral side and the second end of the top portion comprise a first zipper portion of a zipper, and wherein the first end, the second lateral side and the second end of the top portion at the top side of the base portion comprise a second zipper portion of the zipper, the first and second zipper portions configured to removably interlock via manual operation of the zipper.

In another aspect, provided herein is a method of promoting extension of a knee (e.g., passively and/or passively and actively) of an extended supported leg of a user. The method comprises positioning a first mounting strap of a knee extension system (such as passive and/or active knee extension system) over the user's leg at a first side of the knee, the first mounting strap extending between first and second lateral sides of a pliable base portion of a shell of the knee extension system. The method also comprises positioning a second mounting strap of the knee extension system over the user's leg at a second side of the knee, the second mounting strap extending between the first and second lateral sides of the pliable base portion. The first mounting strap is positioned proximate to a first end of the base portion of the knee extension system, and the second mounting strap is positioned proximate to a second end of the base portion of the knee extension system. The method further comprises placing a first base weight of the knee extension system within a first exterior weight pocket of a first plurality of exterior weight pockets positioned on the first lateral side of the base portion of the knee extension system, and placing a second base weight of the knee extension system within a first exterior weight pocket of a second plurality of exterior weight pockets position on the second lateral side of the base portion of the knee extension system. The positioning of the first mounting strap and the positioning of the second mounting strap over the user's leg suspends the shell of the knee extension system from the user's leg beneath a posterior side of the user's knee.

In some embodiments, the method further comprises arranging a compressible support cushion of the knee extension system on a top surface of a top portion of the shell of the knee extension system. In some such embodiments, the method further comprises shortening a length of the first mounting strap and shortening a length of the second mounting strap such that a top side of the support cushion engages the anterior side of the user's knee, and the support cushion is partially compressed.

In some embodiments, the base portion of the of the knee extension system further comprises an inner container within an interior cavity of the base portion, and the method further comprises placing at least one additional weight within the inner container.

In some embodiments, the method user further comprises placing a third base weight of the knee extension system within a second exterior weight pocket of the first plurality of exterior weight pockets on the first lateral side of the base portion of the knee extension system, and placing a fourth base weight of the knee extension system within a second exterior weight pocket of the second plurality of exterior weight pockets on the second lateral side of the base portion of the knee extension system.

These, and other objects, features and advantages of this invention will become apparent from the following detailed description of the various aspects of the invention taken in conjunction with the accompanying drawings.

### BRIEF DESCRIPTION OF DRAWINGS

The accompanying drawings, which are incorporated in and constitute a part of the specification, illustrate embodiments of the invention and together with the detailed description herein, serve to explain the principles of the invention. The drawings are only for purposes of illustrating preferred embodiments and are not to be construed as limiting the invention. It is emphasized that, in accordance with the standard practice in the industry, various features may or may not drawn to scale. The dimensions of features of a drawing may be arbitrarily increased or reduced for clarity of discussion, and therefore the scale of any figure should not limit the scope of the invention. However, many drawings are drawn to scale, and therefore the scale of any components of any figure is specifically disclosed, incorporated herein and part of this invention disclosure.

The foregoing and other objects, features and advantages of the invention are apparent from the following detailed description taken in conjunction with the accompanying drawings in which:

FIG. 1 illustrates an elevational perspective view of an exemplary knee extension system for promoting knee extension via passive and active knee extension, in accordance with an aspect of the present disclosure;

FIG. 2 illustrates an elevational side perspective view of the exemplary knee extension system of FIG. 1 in use on a knee of a leg of a user, in accordance with an aspect of the present disclosure;

FIG. 3 illustrates a side view of the exemplary knee extension system of FIG. 2, in accordance with an aspect of the present disclosure;

FIG. 4 illustrates a top perspective view of the exemplary knee extension system of FIG. 2, in accordance with an aspect of the present disclosure;

FIG. 5 illustrates an elevational perspective view of the exemplary knee extension system of FIG. 1 with a support cushion thereof removed, in accordance with an aspect of the present disclosure;

FIG. 6 illustrates an elevational perspective end view of the exemplary knee extension system of FIG. 5, in accordance with an aspect of the present disclosure;

FIG. 7 illustrates an elevational side perspective view of the exemplary knee extension system of FIG. 5 in use on a knee of a leg of a user, in accordance with an aspect of the present disclosure;

FIG. 8 illustrates a side view of the exemplary knee extension system of FIG. 7, in accordance with an aspect of the present disclosure;

FIG. 9 illustrates a top view of the exemplary knee extension system of FIG. 7, in accordance with an aspect of the present disclosure;

FIG. 10 illustrates an elevational side perspective view of the exemplary knee extension system of FIG. 5 in use on a lower leg of a user, in accordance with an aspect of the present disclosure;

FIG. 11 illustrates an exploded top perspective view of the exemplary knee extension system of FIG. 1, in accordance with an aspect of the present disclosure;

FIG. 12 illustrates an elevational perspective lateral side view of the exemplary knee extension system of FIG. 1 with the support cushion thereof removed, in accordance with an aspect of the present disclosure;

FIG. 13 illustrates an elevational perspective lateral side view of the exemplary knee extension system of FIG. 12 with mounting straps thereof decoupled, in accordance with an aspect of the present disclosure;

FIG. 14 illustrates an bottom perspective lateral side view of the exemplary knee extension system of FIG. 13, in accordance with an aspect of the present disclosure;

FIG. 15 illustrates an elevational perspective lateral side view of the exemplary knee extension system of FIG. 13 with a rigid top portion in an open position with respect to a base portion, in accordance with an aspect of the present disclosure;

FIG. 16 illustrates another elevational perspective lateral side view of the exemplary knee extension system of FIG. 15, in accordance with an aspect of the present disclosure;

FIG. 17 illustrates an elevational perspective lateral side view of the exemplary knee extension system of FIG. 13 with a rigid container thereof removed from a pliable case or shell thereof, in accordance with an aspect of the present disclosure;

FIG. 18 illustrates a top view of a first weight positioned within the container of the exemplary knee extension system of FIG. 1, in accordance with an aspect of the present disclosure;

FIG. 19 illustrates a top view of a second weight positioned within the container of the exemplary knee extension system of FIG. 1, in accordance with an aspect of the present disclosure;

FIG. 20 illustrates an elevational perspective view of a plurality of base weights of the exemplary knee extension system of FIG. 1, in accordance with an aspect of the present disclosure;

FIG. 21 illustrates an elevational perspective view of the support cushion of the exemplary knee extension system of FIG. 1, in accordance with an aspect of the present disclosure; and

FIG. 22 illustrates an end perspective view of the support cushion of FIG. 21, in accordance with an aspect of the present disclosure.

### DETAILED DESCRIPTION

Generally stated, disclosed herein are systems, devices, components and related methods for passively and/or actively promoting, maintaining and restoring knee extension. The systems, devices, components and related methods provide improved knee extension systems, devices, components and related methods that are comfortable, safe, effective and configured for use by a user without assistance. The systems, devices and related methods allow users to easily engage and use the system/device while avoiding pain or discomfort. The systems, devices, components and related methods provide for both passive and active knee extension, and achieve rapid and long-term improved knee extension clinical outcomes. The systems, devices, components and related methods improve knee extension range of motion, reduce stiffness and swelling, and reduce pain, while being able to be used by a user at home or in a therapeutic setting.

The systems, devices, components and related methods provide improved knee extension range of motion, strength, and flexibility of the knee joint. The systems and devices are portable, can be used by a user by themselves (e.g., in a seated or prone position), and provide controlled extension of the knee joint using an applied, controlled force through weight suspension from the user's leg to progressively achieve full knee and leg extension.

The knee extension systems, devices, components and related methods are therapeutic systems, devices, components and related methods that can be combined with other passive and active range of motion techniques, that facilitate long-term knee extension range of motion gains safely and comfortably. The knee extension systems, devices, components and related methods provide graduating knee extension forces to improve knee extension following surgery, injury or disease. The knee extension systems, devices, components and related methods utilize a symmetric gravity-based (passive) graduating weight system for improving range of knee motion and extension, that may be combined with active knee extension to promote, maintain and restore full knee extension.

In this detailed description and the following claims, the words proximal, distal, medial, lateral, superior and inferior may be defined as directional term of reference with respect to the anatomical directions of the human body. For example, a “proximal” portion means a portion of a device or system nearest the torso, while a “distal” portion indicates the portion of the device or system farthest from the torso. As another example, may be “medial” mean towards the midline of the body, and “lateral” may refer to a direction towards the sides or away from the midline of the body. As another example, may be “anterior” mean towards the front of the body or limb, and “posterior” may refer to towards the rear of the body or limb.

The terms “distal” and “proximal” are also be used herein to describe a positional relationship of features. For example, “proximal” and “distal” can be utilized to describe a physical spacing or distance between features (e.g., “proximal” and “distal” features). As another example, “proximal” and variations thereof (e.g., proximate) can mean close or closer to a referenced feature or a user, and the “distal” and variations thereof can mean far or further away from a referenced feature or a user.

However, the term “medial” is also used herein to refer a feature or portion being situated in about the middle or toward the middle of a respective component, portion, aspect, device, member, side, end or any other referenced structure.

Similarly, positions or directions may be used herein with reference to anatomical structures or surfaces. For example, as the systems and methods are described herein with reference to use with a human knee, surfaces, positions, directions or orientations of the systems and methods, and components thereof, may be described with respect to a knee or the anatomical directions/potions related thereto. Further, the systems and methods, and the aspects, components, features and the like thereof, disclosed herein are described with respect to one side of the body for brevity purposes. However, as the human body is relatively symmetrical or mirrored about a line of symmetry (midline), it is hereby expressly contemplated that the systems and methods, and the aspects, components, features and the like thereof, described and/or illustrated herein may be changed, varied, modified, reconfigured or otherwise altered for use or association with another side of the body for a same or similar purpose without departing from the spirit and scope of the invention. For example, the instrumentation and methods, and the aspects, components, features and the like thereof, described herein with respect to a right knee or ankle may be mirrored so that they likewise function with a left knee or ankle. Further, the systems and methods, and the aspects, components, features and the like thereof, disclosed herein are described with respect to a knee for brevity purposes, but it should be understood that the systems and methods may be used with other joints of the body having similar anatomy.

The terms “substantially”, “approximately”, “about”, “relatively” or other such similar terms that may be used throughout this disclosure, including the claims, are used to describe and account for small fluctuations of a value(s), such as due to variations in processing. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05% of an identified value.

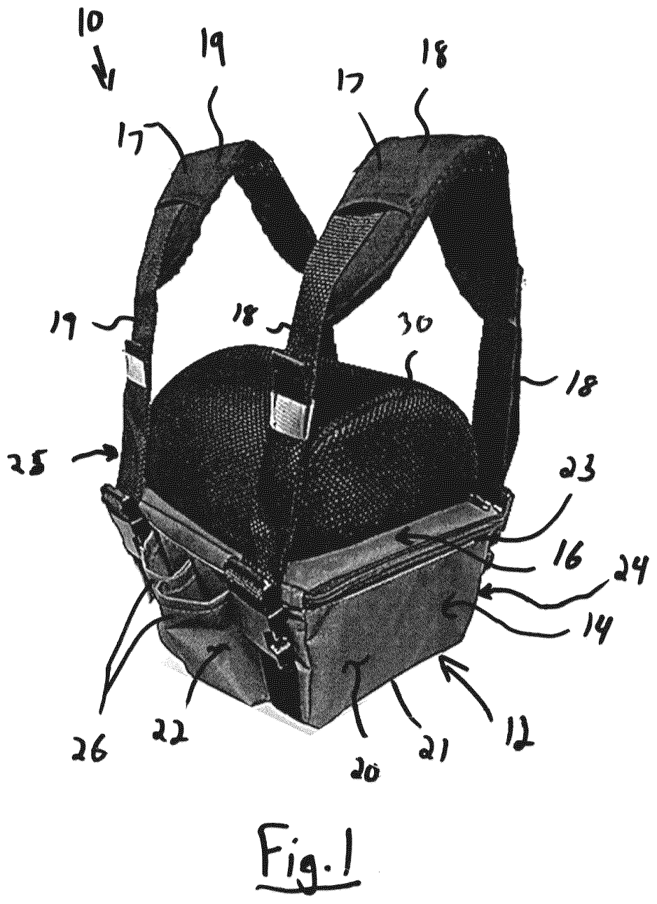

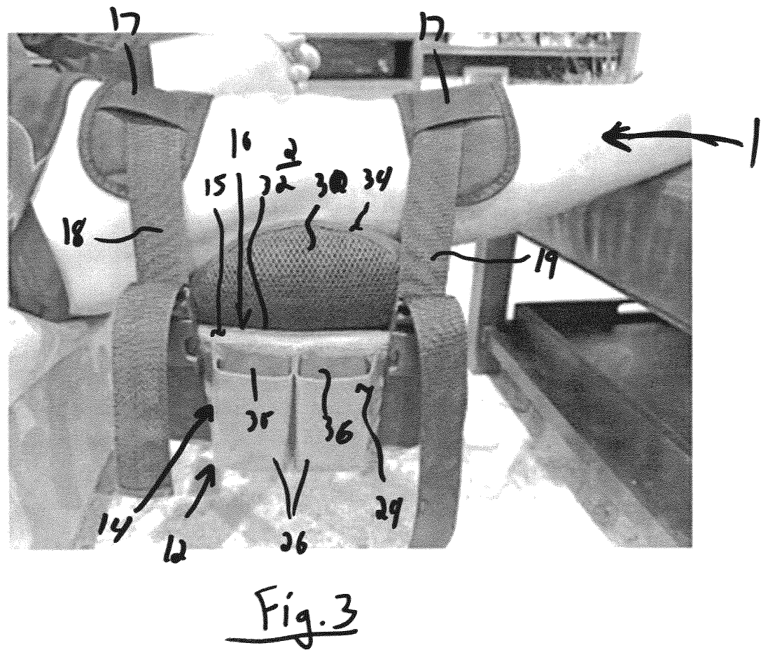

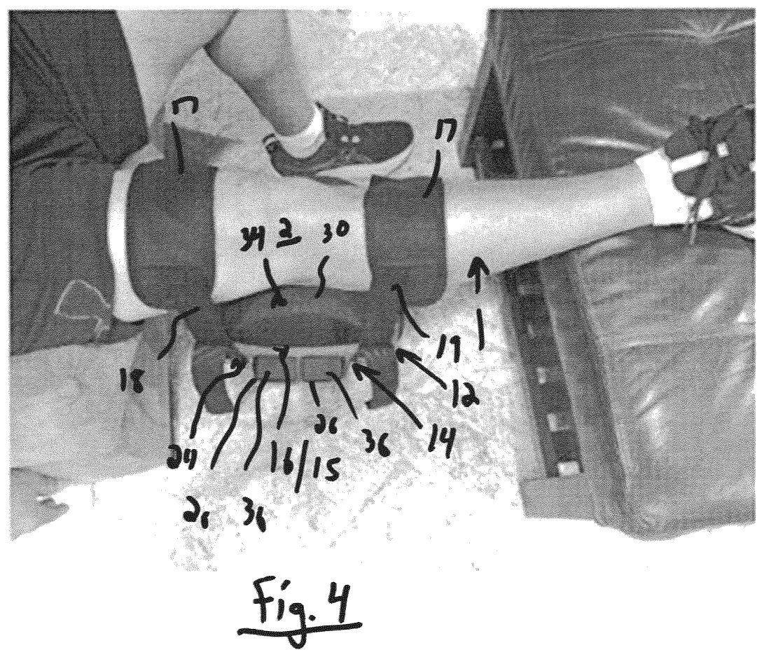

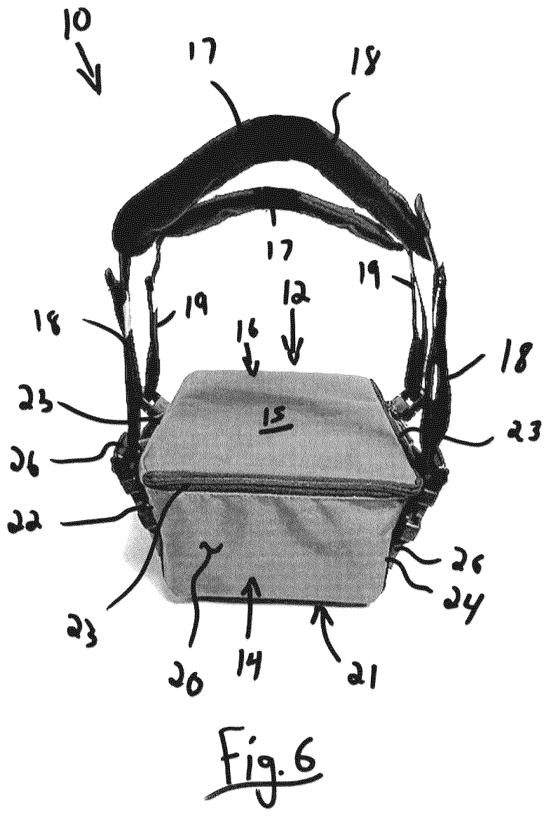

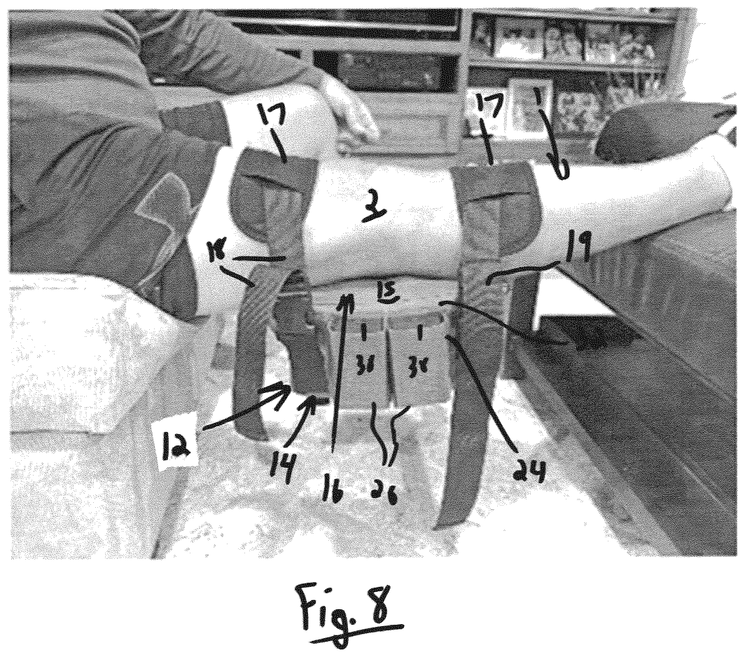

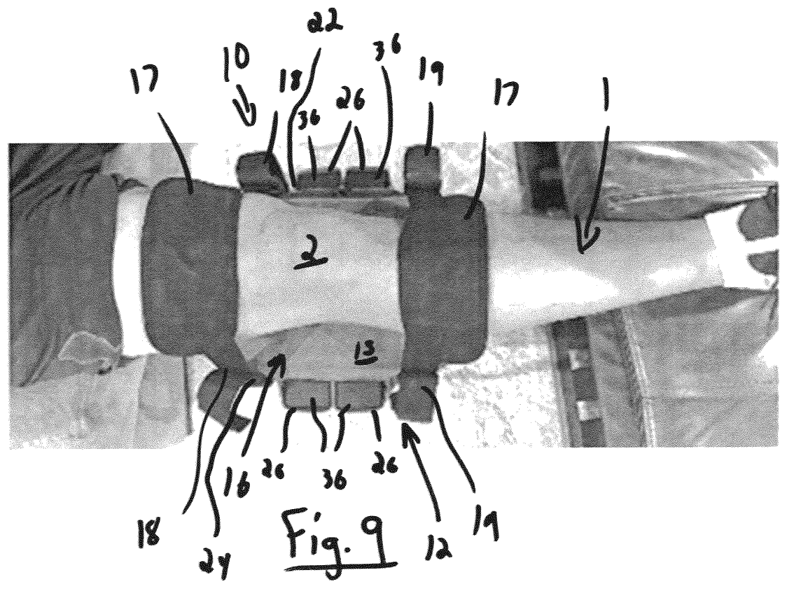

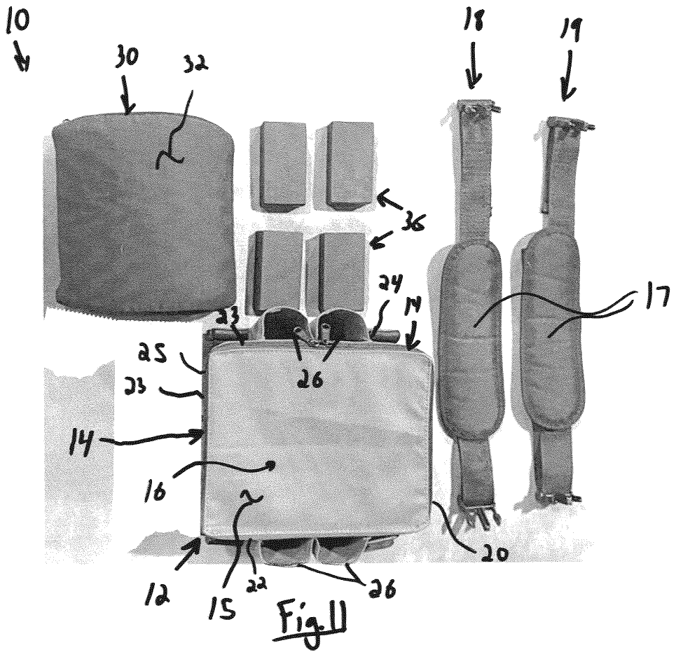

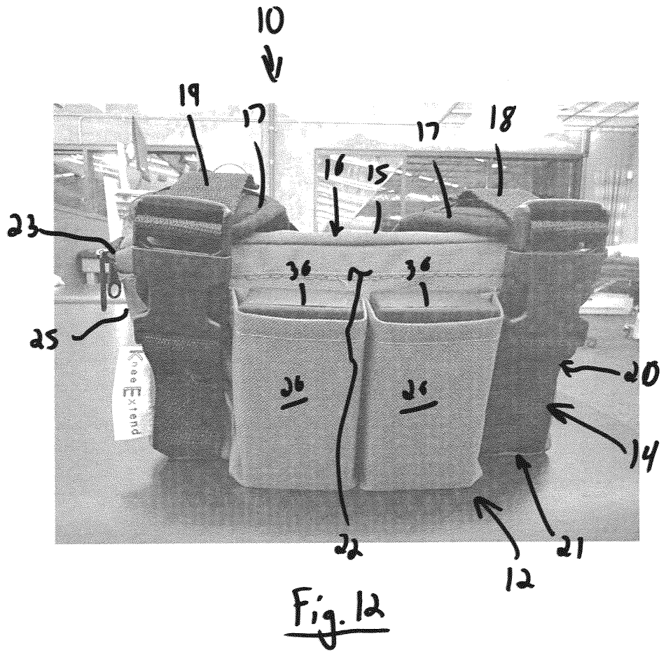

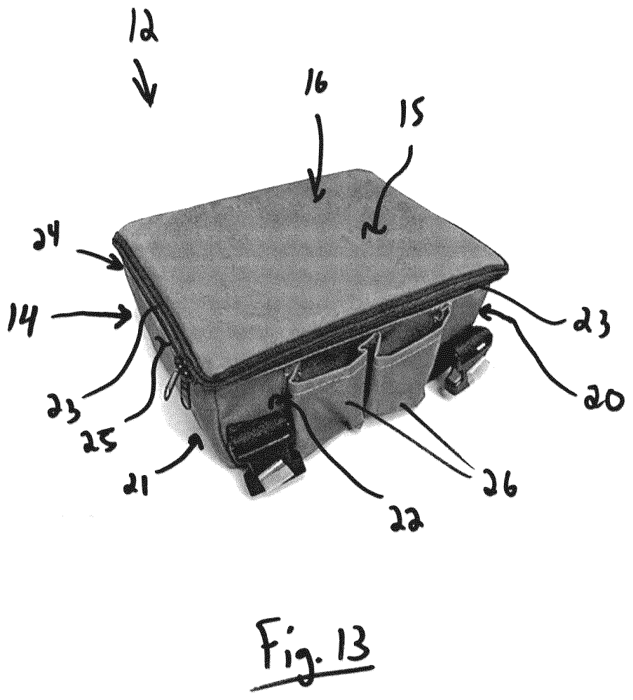

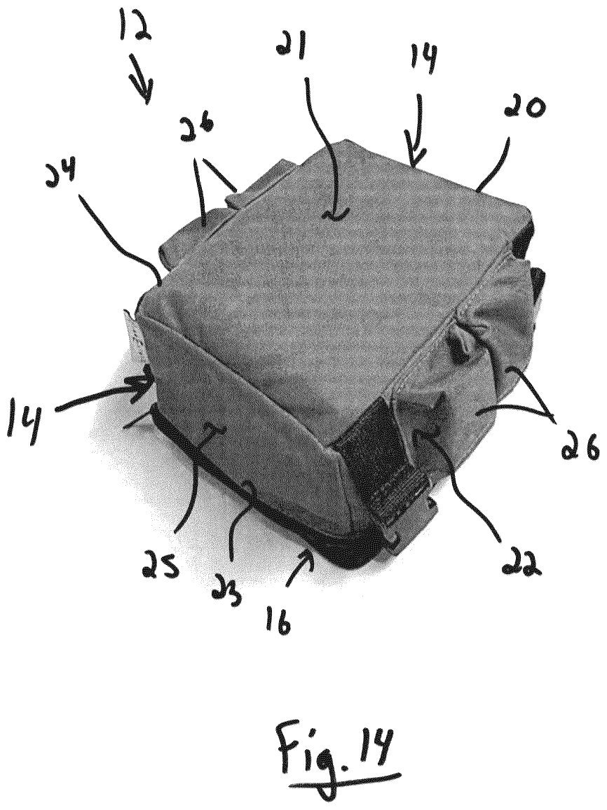

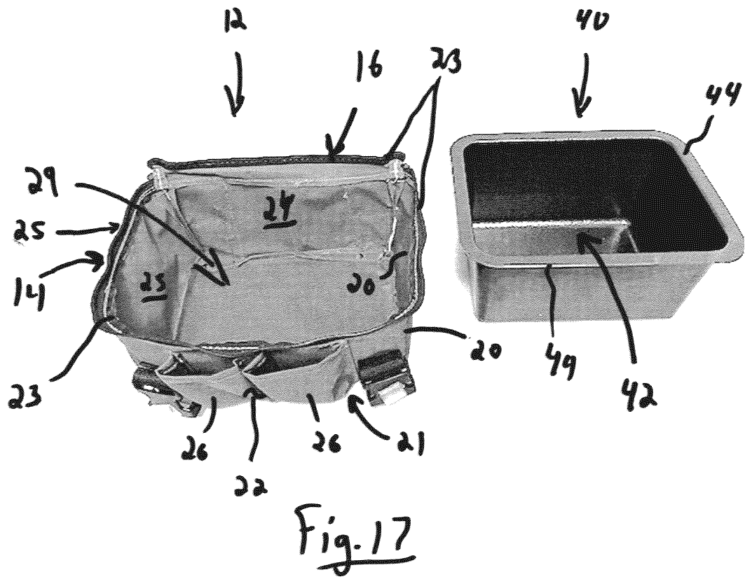

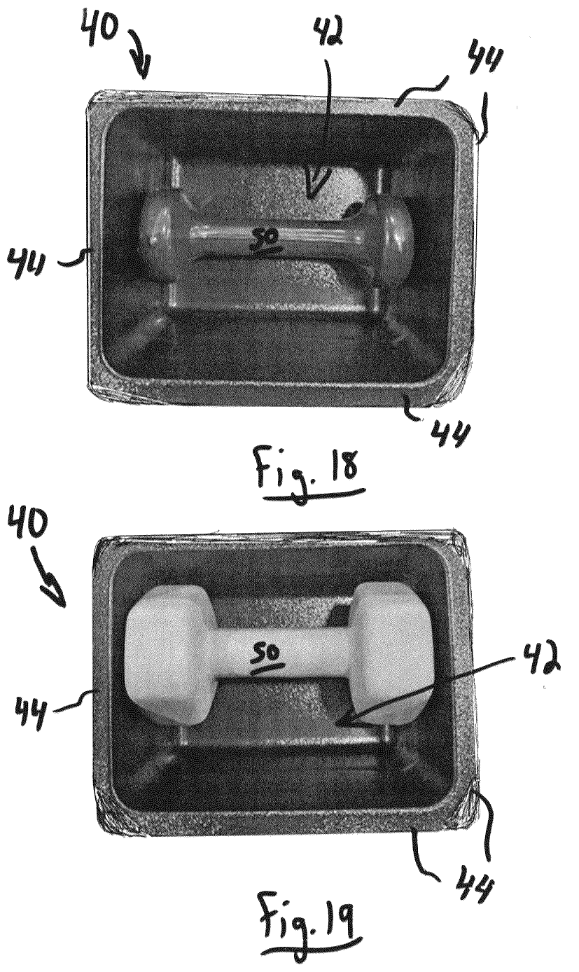

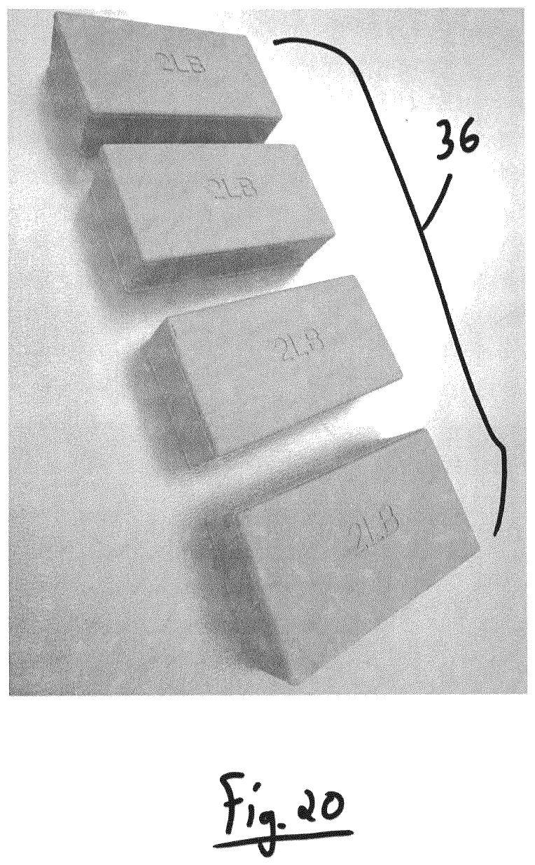

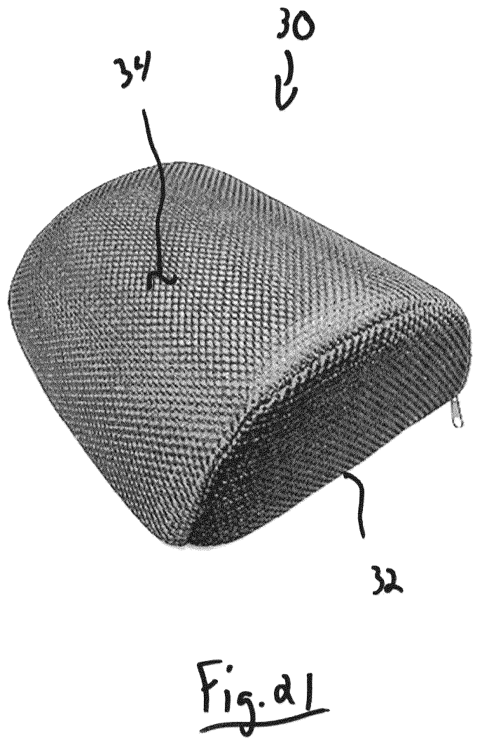

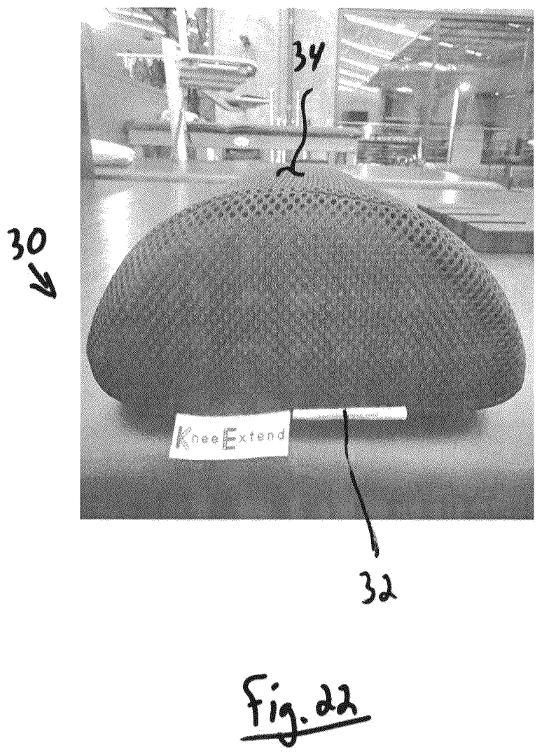

An exemplary knee extension system or device 10, and related methods of using the exemplary system or device 10, for promoting, maintaining and restoring full knee extension is shown in FIGS. 1-22. As shown, the exemplary knee extension system 10 incudes a therapeutic weight case/shell 12 that comprises a base portion 14 and a top portion 16 movably coupled with the base portion 14, a first mounting strap 18 releasably coupled with the shell 12, a second mounting strap 19 releasably coupled with the shell 12, a rigid, hollow container 40, a support cushion 30 and a plurality of base weights 36.

The base portion 14 of the case or shell 12 may be flexible or pliable, such as formed of or from a woven or non-woven fabric, sheet or the like. For example, the base portion 14 may be easily manually deformable, and may or may not retain its own shape. In some embodiments, the base portion 14 may be formed of fabric materials, and its subcomponents may be sown and/or adhered together.

As shown in FIGS. 1-17, the base portion 14 may comprise, form or define a first end 20, a second end 25, a first lateral side 22 extending between the first and second ends 20, 25, a second lateral side 24 extending between the first and second ends 20, 25, a bottom side 21 and a top side 23. The second lateral side 24 may oppose the first lateral side 22, and the second end 25 may oppose the first end 20. Similarly, the top side 23 may oppose the bottom side 21.

As shown, in some embodiments the lateral width of the base portion 14 extending between the first and second lateral sides 22, 24 may be less than a length of the base portion 14 extending between the first and second end 20, 25. In some embodiments, the base portion 14 may be at least about 8 inches long, such as about 10 inches or about 12 inches long. In some embodiments, the base portion 14 may be at least about 6 inches wide, such as about 8 inches or about 10 inches wide. In some embodiments, the base portion 14 (and/or an interior cavity 29 thereof) may define a rectangular or square shape in cross-section, which may enlarge in width and/or length in a height direction extending from the bottom side 21 to the top side 23 (e.g., the base portion 14 and/or an interior cavity 29 thereof may taper inwardly as it extends from the top side 23 to the bottom side 21. However, the base portion 14 (and the interior cavity 29 thereof) may be of any shape and size.

The base portion 14 of the case or shell 12 includes a plurality of exterior base weight pockets 26, as shown in FIGS. 1-17. The base weight pockets 26 may be open-top pockets such that the cavity thereof is easily accessible from a top side of the base weight pockets 26. However, the base weight pockets 26 may include a cover or top portion that can be opened or otherwise moved to open the base weight pockets 26. The base weight pockets 26 and the plurality of base weights 36 may be cooperatively configured, such as the shape and size thereof, such that a base weight 36 can be placed in, and retained by or within, a corresponding pocket 26. In some embodiments, the base weights 36 may be of a rectangular shape (rectangular prisms or cuboids), and the pockets 26 may thereby be rectangular shaped pockets that define an inner cavity that is slightly larger than the size/shape of the base weights 36. However, the base weights 36 and the base weight pockets 26 may be of any operable size and/or shape. In some embodiments, the base weight pockets 26 may be configured such that only one (i.e., a singular) base weight 36 is received with a pocket 26.

The plurality of base weights 36 may be of the same weight or of differing weights. In some embodiments, the base weights 36 may be high density bars, such as coated (silicone rubber coated) steel bars, that fit within the base weight pockets 26 of the base portion 14. In some exemplary embodiments, each base weight 36 may be the range of about 1 lb to about 4 lbs, such as within the range of about 1 lb to about 3 lbs, such as being about 2 lbs. The base weights 36 may be formed of any dense material, such as but not limited to a metal material, composite material or masonry material (e.g., concrete). During use, a user may place however many base weights 36 the wish in the base weight pockets 26 based on the amount of passive knee extension force is desired.

As shown in FIGS. 1-17, the first lateral side 22 may include a first plurality of the exterior weight pockets 26, and the second lateral side 24 may include a second plurality of the exterior weight pockets 26. In some embodiments, as shown, the first plurality of the exterior weight pockets 26 may be longitudinally arranged along the length of the first lateral side 22, such as being positioned where the first and second mounting straps 18, 19 couple with (or extend from) the first lateral side 22. Similarly, in some embodiments, the second plurality of the exterior weight pockets 26 may be longitudinally arranged along the length of the second lateral side 34, such as being positioned where the first and second mounting straps 18, 19 couple with (or extend from) the second lateral side 24. The base weight pockets 26 may be positioned on opposing sides of the base portion 14 of the case or shell 12 such that they are symmetrically disposed, which may balance the base portion 14 when the base weight pockets 26 are positioned therein. In the exemplary illustrated embodiments, the first and second lateral sides 22, 24 each include a pair of base weight pockets 26, but in alternative embodiments the first and second lateral sides 22, 24 may only have one base weight pocket 26 or three or more base weight pockets 26.

As noted above, the first mounting strap 18 may extend between the first and second lateral sides 22, 24 of the base portion 14 of the case or shell 12, and the second mounting strap 19 may extend between the first and second lateral sides 22, 24 of the base portion 14 of the case or shell 12. As shown in FIGS. 1-10 and 12, the first mounting strap 18 may extend between the first and second lateral sides 22, 24 of the base portion 14 proximate to the first end 20 of the base portion 14 (and distal to the second end 25), and the second mounting strap 19 may extend between the first and second lateral sides 22, 24 of the base portion 14 proximate to the second end 25 of the base portion 14 (and distal to the first end 20).

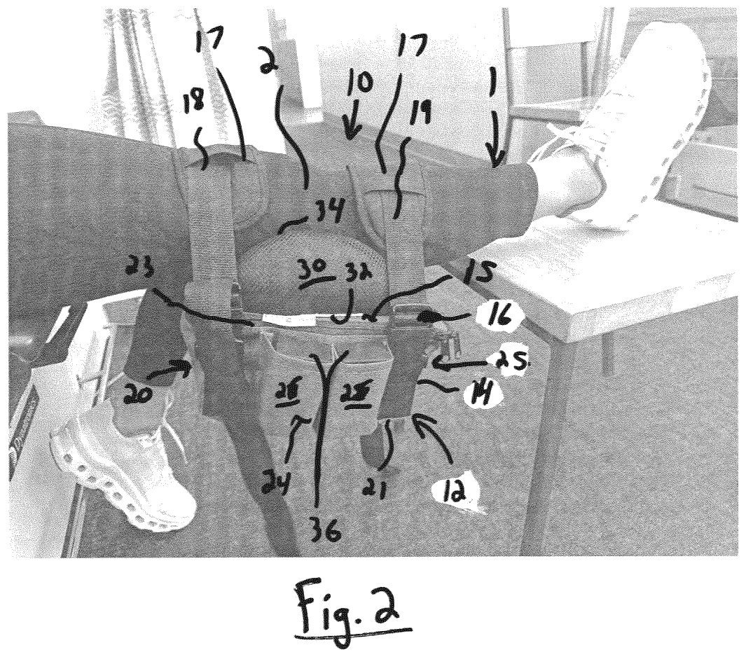

In use, the first and second mounting straps 18, 19 extend between the first and second lateral sides 22, 24 and over the top portion 16 of the shell 10 (and potentially the support cushion positioned thereon), as shown in FIGS. 1-10 and 12. In this way, the first and second mounting straps 18, 19 may extend over a user's leg 1 with the user's leg 1 extending between the first and second mounting straps 18, 19 and the therapeutic weight case/shell 12. For example, as shown in FIGS. 2-4 and 7-9, the first mounting strap 18 may be configured to extend over an anterior side of a distal portion of a user's thigh, and the second mounting strap 19 may be configured to extend over an anterior side of a proximal portion of the user's shin, such that the first and second mounting straps 18, 19 are positioned on opposing sides of the knee 2 past incisions or other areas of discomfort on/about the knee 2.

As shown, in some embodiments, the first and second mounting straps 18, 19 may be elongate, relatively soft and flexible or pliable straps or material strips, such as similar to shoulder straps of duffel bags or backpacks. The first and second mounting straps 18, 19 may comprise or be formed of webbing or a woven or nonwoven fabric or like material. The first mounting strap 18 may be removably coupled with a first portion of the first lateral side 22 and removably coupled with a first portion of the second lateral side 24, and the second mounting strap 19 may be removably coupled with a second portion of the first lateral side 22 and removably coupled with a second portion of the second lateral side 24. For example, the first and second mounting straps 18, 19 and the first and second lateral sides 22, 24 of the base portion 12 may include mating clips, buttons, fasteners, Velcro, buckles or other releasably coupling mechanisms or devices. End portions of the first and second mounting straps 18, 19 may thereby selectively coupled with and decoupled from the first and second lateral sides 22, 24 of the base portion 12, as shown in FIGS. 1-17.

As also shown in FIGS. 1-12, the first and second mounting straps 18, 19 may be length-adjustable. For example, the first and second mounting straps 18, 19 may include a cinch strap, buckles, strap adjuster or adjustment mechanisms that allows for the lengthening and shortening of the length of the mounting straps18, 19 (e.g., via adjustment of the pathway of the strap through the buckle, strap adjuster or other adjustment mechanism). For example, in some embodiments, end portions of the first and second mounting straps 18, 19 may pass through an adjuster portion of a coupling buckle that removably mates with a mating buckle coupled with the first and second lateral sides 22, 24 of the base portion 12. The coupling buckles may include one or more slots and bars, through and over which the end portions of the first and second mounting straps 18, 19 are threaded, and doubled over itself. The coupling buckles may be configured such that tension from a medial portion of the first and second mounting straps 18, 19 causes the straps 18, 19 to bind against itself and/or on the slots and bars, to lock the straps 18, 19 in place. However, the coupling buckles may also be configured such that tension applied from the ends of the first and second mounting straps 18, 19 causes the medial portion of the first and second mounting straps 18, 19 to slide through the coupling buckle to shorten the length of the medial portion of the straps 18, 19 extending from the coupling buckles. Further, the coupling buckle may also be configured such that the end portions of the straps 18, 19 can be manually fed or forced through the coupling buckle so as to lengthen the medial portion of the straps 18, 19 extending from the coupling buckles. Such coupling buckles may thereby provide for releasably coupling or mating the end portions (e.g., both end portions) of the first and second mounting straps 18, 19 with the first and second lateral sides 22, 24 of the base portion 12, and selective lengthen or shorten the length of the medial portions if the first and second lateral sides 22, 24 extending between the first and second lateral sides 22, 24.

It is noted that shortening of the first and second mounting straps 18, 19 may be utilized to pulling the support cushion 30 (via the rigid top 16, rigid container 40 and the therapeutic weight case/shell 12 itself, as explained further below) up against the back/posterior side of the user's leg 1 and/or knee 2. Conversely, the lengthening of the first and second mounting straps 18, 19 may be utilized to ensure that the position the support cushion 30 and the case/shell 12 hang sufficiently far from the back/posterior side of the user's leg 1 and/or knee 2 such and avoid undue pressure or discomfort on the back/posterior side of the user's leg 1 and/or knee 2.

As shown in FIGS. 1-12, the first and second mounting straps 18, 19 may each include a cushioned strap pad 17 that is slidable along a length of the respective mounting strap 18, 19. The cushioned strap pad 17 may be may be cushioned so as to comfortably engage and extend over a user's leg 1, for example. The cushioned strap pad 17 may also be slidable or otherwise translatable along the length of the first and second mounting straps 18, 19 to account for changes in the lengths of the first and second mounting straps 18, 19, and to ensure the cushioned strap pad 17 engaged with the user during use. For example, the first and second mounting straps 18, 19 may pass through a through channel or aperture of a cushioned strap pad 17. The cushioned strap pad 17 may also be configured to spread out the forces applied by the first and second mounting straps 18, 19. For example, the cushioned strap pads 17 may defines a width that is greater than a width of the strap portion of the first and second mounting straps 18, 19.

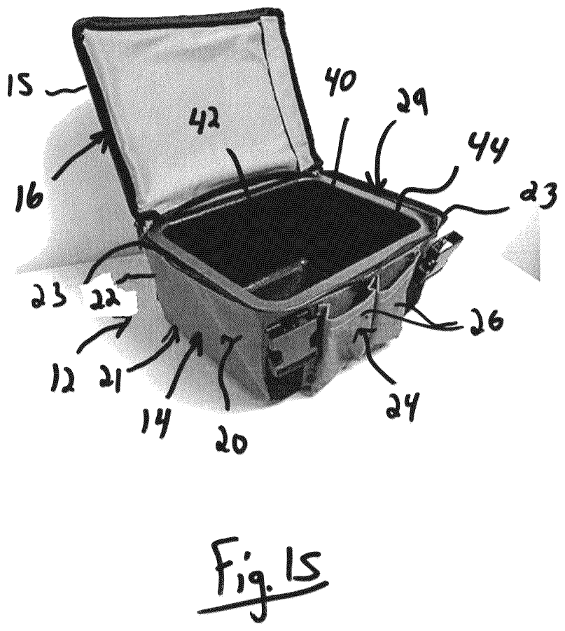

As noted above, and shown in FIGS. 15-17, the base portion 14 may form or include an interior cavity, compartment or void 29. The interior cavity 29 of the base portion 14 of the shell 12 is configured to removably contain the rigid container 40, as shown in FIGS. 15-17. As shown, the interior cavity 29 of the base portion 14 and the rigid container 40 may be configured such that the rigid container 40 may be relatively snuggly removably contained or positionable within the interior cavity 29. For example, as shown, the interior cavity 29 and the rigid container 40 may define substantially similar heights, widths and lengths such that the rigid container 40 substantially fills the interior cavity 29 when positioned therein. The rigid container 40 may be sized and shaped the same or substantially similar as that of the base portion 14 as described above, which is not repeated here for brevity sake.

As also shown, the rigid container 40 may be an open topped container (e.g., plastic container) that includes an inner compartment, void, cavity or compartment 42 and a top lip, rim or edge 44 extending around an open top periphery of the inner compartment 42. The rigid container 40 may thereby be a rigid, hollow container. The rigid container 40 may act to give the pliable base portion 14 its form or structure. The pliable base portion 14 may hereby be a pliable sleeve or bag that extends about the rigid container 40. The rigid container 40 may be formed of any sturdy, rigid material, such as being a vacuum formed open topped plastic container.

The top lip of the open top periphery of the rigid container provides a stable base or structure for the rigid lid to remain stiff against the downward pressure is applied thereto during knee extension, such as when the support cushion is positioned on the rigid lid pressed against the back/posterior side of the user's leg 1 and/or knee 2 and the knee 2 is extended. When the rigid container 40 is positioned within the interior cavity 29 of the base portion 14, the rigid container 40 provides a sturdy, rigid base or support on which the rigid top portion 16 can extend over and provide static resistance against a downward force of a knee 2 in extension (i.e., while extending) and/or flexion (i.e., while flexing). Further, as shown in FIGS. 15, 18 and 19, when the rigid container 40 is positioned within the interior cavity 29 of the base portion 14, the compartment 42 of the rigid container 40 provides a relatively large space for holding or containing one or more weight or weighted object 50 to increase the passive knee extension force applied by the system 10 during use. In this way, the compartment 42 of the rigid container 40 provides for many different weights 50 to be used with the system 100 to customize the total weight f the system 100, and thereby the amount of passive/gravitational force acting on a user's leg/knee 1/2 to extend the user's knee 2.

As shown in FIGS. 15-19, the top rim 44 may define an extended width or thickness, such as at least about ¼″, such as about ½″, to provide sufficient support to the rigid top portion 16 in a closed position of the rigid top portion 16. Further, the base portion 14 and the rigid container 40 may be configures such that the top rim 44 is positioned substantially even, or positioned just above, the top side of the base portion 14 (when the rigid container 40 is positioned within the interior cavity 29) such that a bottom side of the rigid top portion 16 engages the top rim 44 of the rigid container 40 in the closed position of the rigid top portion 16.

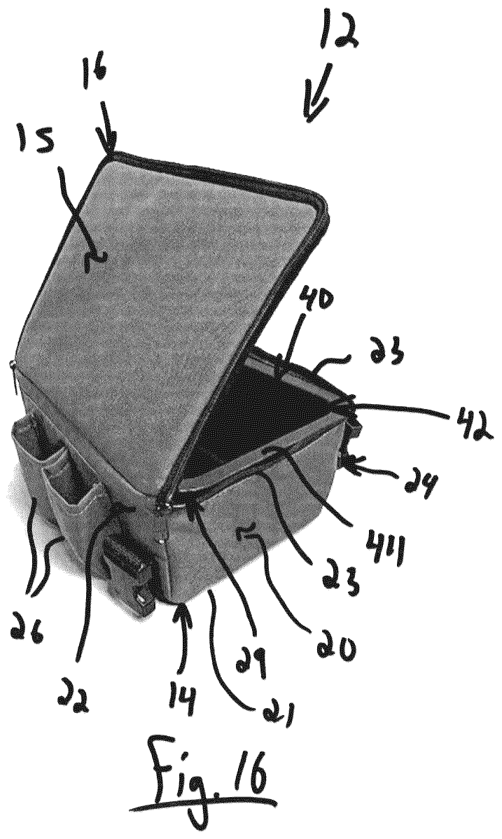

In some embodiments, the top portion 16 of the shell/case 12 is movable with respect to the base portion 12 of the shell/case 12 between a closed position wherein the top portion 16 extends over the top side 23 of the base portion 12 and the top rim 44 of the container 40 as shown in FIGS. 1-13, and an open position wherein at least a portion of the top portion 16 is spaced from the top side 23 of the base portion 12 and the top rim 44, and the inner compartment 44 of the container 42 is at least partially exposed, as shown in FIGS. 15 and 16. It is noted that in the closed position, the bottom side of the top portion 16 may physical engage with the top rim 44 of the container 40, and the container 40 may physically support and maintain the position of the top portion 16. Conversely, in the open position, the top rim 44 and the inner compartment 44 of the container 42 is exposed and accessible such that a weight 50 can be manually placed or positioned into the inner compartment 44 of the container 42, or a weight 50 taken out or removed from inner compartment 44 of the container 42, as shown in FIG. 15.

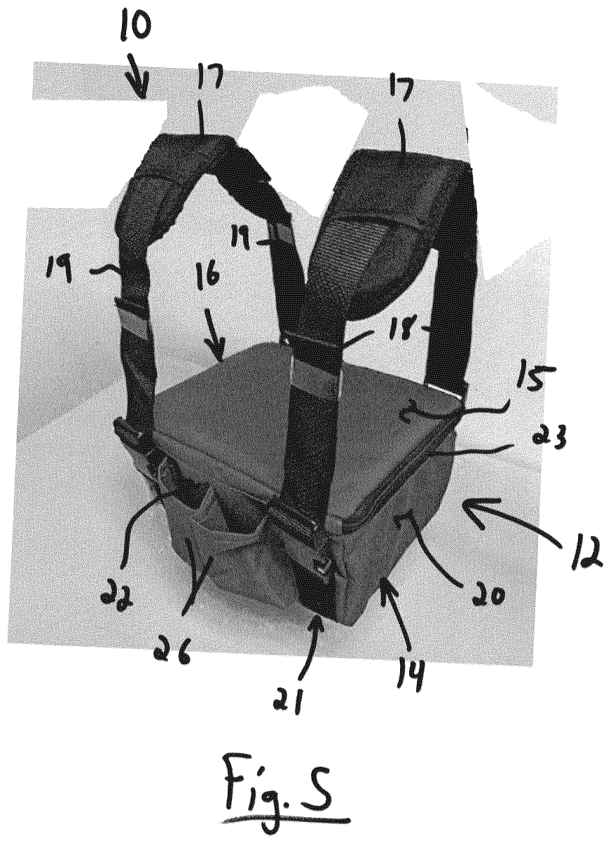

In the exemplary illustrative embodiment, a first lateral side of the top portion 16 and the first lateral side 22 of the base portion 12 of the case/shell 12 at the top side 23 of the base portion 12 form a living hinge such that the top portion 12 is rotatable about the living hinge with respect to the base portion 12 between the closed and open positions, as shown in FIGS. 5, 12, 13 and 15-17. As another example, a side of the top portion 16 and at least a portion of the top side 23 of the lateral sides 22, 24 or the first or second end 20, 25 may be coupled to a hinge component or member. However, in other embodiments the top portion 16 may be otherwise movable with respect to the base portion 12. For example, the top portion 16 may be pivotable with respect to the base portion 12, or removable from the base portion 12. As another example, the top portion 16 may be slidable with respect to the base portion 12.

When in the top portion 16 is in the closed position, the top portion 16 and the base portion 12 may be sealed, coupled or interlocked together to retain the closed position of the top portion 16 and/or to seal or securely close the inner cavity 29 and the compartment 42 of the container 10, such as to ensure that any weight 50 positioned within the compartment 42 of the container 10 is securely maintained thereon. In some such embodiments, a peripheral portion of the rigid top portion 16 and corresponding peripheral portions of the top side 23 of the case/shell 12 may include a zipper or other coupling mechanism or device to removably couple, seal or interlock the portions together. For example, as shown in FIGS. 5, 6, 11, 13, 14, 16 and 17, a first end, a second lateral side and a second end of the top portion 16 that form a peripheral portion of the top portion 16 may be configured to removably couple with a portion of the top side 23 of the base portion 12 formed by the first end 20, the first lateral side 22 and the second end 25 in the closed position of the top portion 16. In the illustrated exemplary embodiment, the first end, the second lateral side and the second end of the top portion 16 comprise a first zipper component or portion of a zipper, and the portion of the top side 23 of the base portion 12 formed by the first end 20, the first lateral side 22 and the second end 25 of the base portion 12 comprises a second zipper component or portion of a zipper, the first and second zipper components configured to removably interlock via manual operation of the zipper.

As shown in FIGS. 1-10, the support cushion 30 may or may not be positioned on the top side or surface 15 of the rigid top portion 16 of the case/shell 12 when the top portion 16 is in the closed position. The support cushion 30 may be a compressible, resilient, cushion, pad or pillow, such as a foam cushion or pillow, that is positionable on the top side 15 of the rigid top portion 16 of the base portion 12 (when the top portion 16 is in the closed position). As shown in FIGS. 1-4, 21 and 22, the support cushion 30 may define a substantially flat bottom side 32 that engages the top side or surface 15 of the top portion 16 when positioned on the top portion 16. As also shown, the support cushion 30 may a convex or arched top side 34. The top side 34 of the support cushion 30 may be arcuately convex in a direction extend from a first end to a second end of the support cushion 30, which correspond to the first and second ends 20, 22 of the base portion 12 of the case/shell 12 when the support cushion 30 is positioned on the top portion 16 of the case/shell 12.

The system 100 is configured such that when the support cushion 30 is positioned on the top side 15 of the rigid top portion 16 (with the top portion 16 in the closed position), the first and second straps 18, 19 can be adjust such that the top side 34 of the support cushion 30 engages the a posterior or back side of a knee 2 or leg 1 of the user, and the support cushion 30 provides support and/or resistance to the back side of the knee 2 or leg 1 of the user during knee extension, as shown in FIGS. 1-4. The support cushion 30 may thereby be partially compressed during use, as shown. In use, the user can actively extend their knee 2 in extension to force the posterior side of their knee 2 against the support cushion 30 (and the rigid top portion 16, and the rigid container 40 therebelow via the rim portion 44) (which may thereby compress the support cushion 30) to provide for active knee extension exercise or forces.

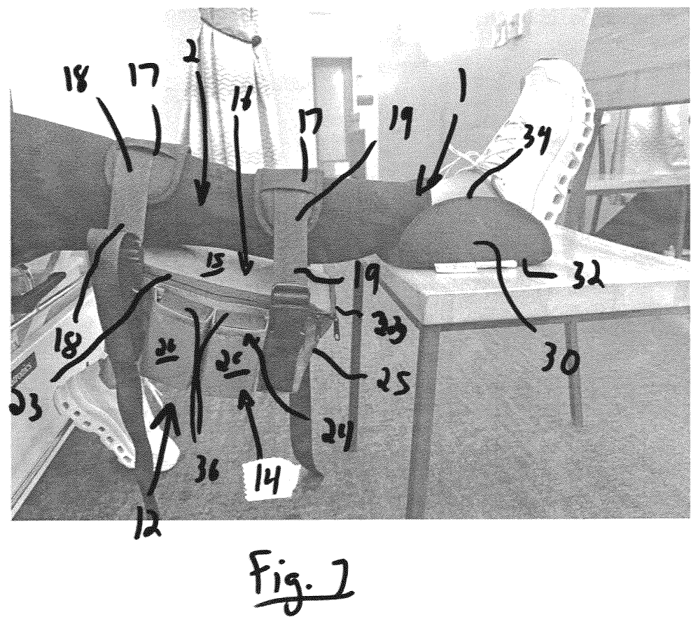

The support cushion 30 can thus provide cushioning against a posterior side (or anterior side) of a user's leg 1 or knee 2. When positioned on the rigid top portion 16, the support cushion 30 may assist in supporting a knee 2 or leg 1 in a certain limited degree of flexion, and configured with sufficient compression or resiliency such that the support cushion 30 compresses to allow a knee 2 to straighten/extend (i.e., move in extension) while using the system 10. The support cushion 30 may thereby provide support and comfort during both passive and active knee extension. As knee extension of a user progresses, the support cushion 30 can be removed from the top portion 16 allowing for greater extension, as shown in FIGS. 5-10. Further, the support cushion 30 may not be positioned on (or removed form) the rigid top portion, and instead be used to support a user's foot or ankle in an elevated, extended position, as shown in FIG. 7.

The top lip 44 of the open top periphery of the rigid container 40 may thereby provide a stable base or structure for the rigid top portion or lid 16 to remain stiff against the downward pressure applied thereto during knee extension, such as when the support cushion 30 is positioned on the rigid top lid portion 16 and pressed against the back/posterior side of the user's leg 1 and/or knee 2 and the knee 2 is extended. The rigid container 40, and the therapeutic weight case/shell 12 and the rigid top portion 16, are configured to provide static resistance against a downward force of a knee in extension (i.e., while extending) and/or flexion (i.e., while flexing) during use of the system 10.

As shown, the system 10 thereby provides downward passive force/pressure to a user's knee 2 and leg 1 during use of the system, which can be gradually increased by placing additional base weights 36 in the external pockets 26 and/or additional weight 50 into the compartment 42 container 40, as tolerated or needed by the user. Active knee extension may occur when the user flexes their leg muscles (e.g., contracts their quadriceps muscle) into the rigid top portion 16 and/or the support cushion 30 to force the extension/straightening of the user's knee/leg 2/1. It is noted that even if the support cushion 30 is not positioned on the rigid top portion 16, a user may still activate their leg muscles (e.g., contracts their quadriceps muscle) to provide active knee extension during a passive knee extension force is applied by the system 10 via base weights 36 and/or additional weight 50.

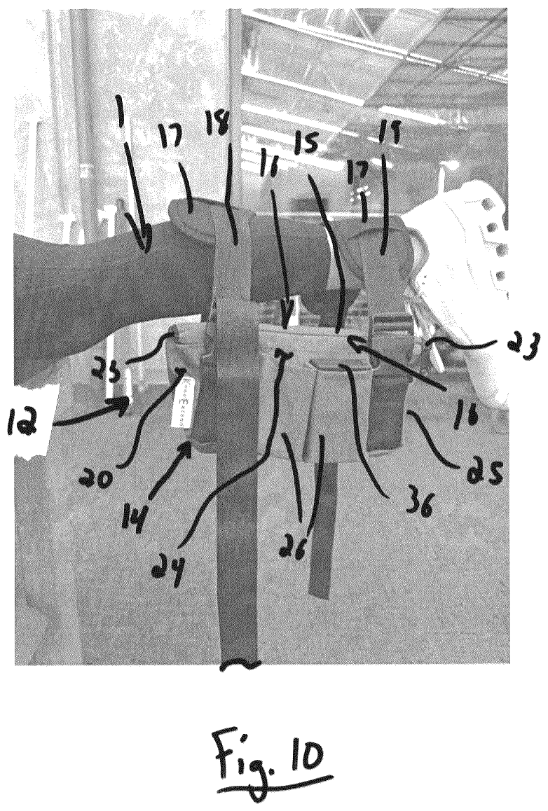

It is also noted that the system 10 may be utilized with parts of the body other than a user's knee 2 to provide exercise and/or therapeutic treatment. For example, as shown in FIG. 10, the system 10 may be coupled to a user's lower leg. In such a configuration, the system may be utilized to provide passive knee extension (via weight/gravity) of the user's knee 2. For example, the user may lay prone, and the weight provided by the base weights 36 and/or additional weight 50 will act to force the user's leg 1 into extension. As another example, with e base weights 36 and/or additional weight 50 installed in the system 10, the first and second straps 18, 19 may extend over a armes, the user can walk, squat, navigate stairs, or otherwise carry the system 10 to allow the weight of the system 10 to provide resistance.

As may be recognized by those of ordinary skill in the art based on the teachings herein, numerous changes and modifications may be made to the above-described and other embodiments of the present disclosure without departing from the scope of the disclosure. The components of the instruments, guides, implants, plates, and/or systems as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the instruments, guides, implants, plates, and/or systems may include more or fewer components or features than the embodiments as described and illustrated herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or device that “comprises,” “has,” “includes,” or “contains” one or more steps or elements possesses those one or more steps or elements, but is not limited to possessing only those one or more steps or elements. Likewise, a step of a method or an element of a device that “comprises,” “has,” “includes,” or “contains” one or more features possesses those one or more features, but is not limited to possessing only those one or more features. Furthermore, a device or structure that is configured in a certain way is configured in at least that way, but may also be configured in ways that are not listed.

The invention has been described with reference to the preferred embodiments. It will be understood that the operational embodiments described herein are exemplary of a plurality of possible arrangements to provide the same general features, characteristics, and general system operation. Modifications and alterations will occur to others upon a reading and understanding of the preceding detailed description. It is intended that the invention be construed as including all such modifications and alterations.

1. A knee extension system, comprising:
a shell comprising a pliable base portion and a rigid top portion, wherein the pliable base portion comprises a first end, a second end, a first lateral side extending between the first and second ends comprising a first plurality of exterior weight pockets, a second lateral side extending between the first and second ends comprising a second plurality of exterior weight pockets, a bottom side, a top side and an interior cavity;
a first mounting strap extending between the first and second lateral sides proximate to the first end;
a second mounting strap extending between the first and second lateral sides proximate to the second end;
a rigid, hollow container with an open top positioned within the interior cavity;
a compressible support cushion positionable on a top surface of the top portion of the shell; and
a plurality of base weights individually positionable within the first and second plurality of exterior weight pockets,
wherein the top portion of the shell is movable with respect to the base portion of the shell between a closed position wherein the top portion extends over the top side of the base portion and the top of the container, and an open position wherein at least a portion of the top portion is spaced from the top side of the base portion and the top of the container is exposed.

2. The system of claim 1, wherein the first mounting strap extends between the first and second lateral sides and over the top portion of the shell, and wherein the second mounting strap extends between the first and second lateral sides and over the top portion of the shell.

3. The system of claim 1, wherein the first mounting strap is configured to extend over an anterior side of a distal portion of a user's thigh, and the second mounting strap is configured to extend over an anterior side of a proximal portion of the user's shin.

4. The system of claim 3, wherein the first mounting strap is a flexible, length-adjustable strap that comprises a first cushioned strap pad that is slidable along a length of the first strap, and the second mounting strap is a flexible, length-adjustable strap that comprises a second cushioned strap pad that is slidable along a length of the second strap.

5. The system of claim 4, wherein the first cushioned strap pad defines a width that is greater than a width of the strap of the first mounting strap, and the second cushioned strap pad defines a width that is greater than a width of the strap of the second mounting strap.

6. The system of claim 1, wherein the first mounting strap is removably coupled with a first portion of the first lateral side and removably coupled with a first portion of the second lateral side, and wherein the second mounting strap is removably coupled with a second portion of the first lateral side and removably coupled with a second portion of the second lateral side.

7. The system of claim 6, wherein the first plurality of exterior weight pockets are arranged between the first and second portions of the first lateral side, and the second plurality of exterior weight pockets are arranged between the first and second portions of the second lateral side.

8. The system of claim 7, wherein the first plurality of exterior weight pockets define open top sides, and the second plurality of exterior weight pockets define open top sides.

9. The system of claim 1, wherein the plurality of base weights each a rubber coated steel bar.

10. The system of claim 1, wherein the plurality of base weights each define a total weight within the range of about 1 lb and about 3 lbs.

11. The system of claim 1, wherein the compressible support cushion is positioned on the top surface of the top portion of the shell with the top portion in the closed position.

12. The system of claim 1, wherein the compressible support cushion defines a substantially flat bottom side that engages the top surface of the top portion and a convex top side that engages a posterior side of a knee.

13. The system of claim 1, wherein a first lateral side of the top portion and the first lateral side of the base portion at the top side of the base portion are coupled and form a living hinge such that the top portion is rotatable about the living hinge between the closed and open positions.

14. The system of claim 13, wherein a first end, a second lateral side and a second end of the top portion form a peripheral portion of the top portion, and wherein the first end, the second lateral side and the second end of the top portion are configured to be removably coupled with a portion of the top side of the base portion formed by the first end, the second lateral side and the second end of the base portion in the closed position of the top portion.

15. The system of claim 14, wherein the first end, the second lateral side and the second end of the top portion comprise a first zipper component of a zipper, and wherein the portion of the top side of the base formed by the first end, the second lateral side and the second end of the base portion comprise a second zipper component of the zipper, the first and second zipper components configured to removably interlock via manual operation of the zipper.

16. A method, comprising:
promoting extension of a knee of an extended supported leg of a user, comprising:
positioning a first mounting strap of a knee extension system over the user's leg at a first side of the knee, the first mounting strap extending between first and second lateral sides of a pliable base portion of a shell of the knee extension system;
positioning a second mounting strap of the knee extension system over the user's leg at a second side of the knee, the second mounting strap extending between the first and second lateral sides of the pliable base portion, wherein the first mounting strap is positioned proximate to a first end of the base portion of the knee extension system, and the second mounting strap is positioned proximate to a second end of the base portion of the knee extension system;
placing a first base weight of the knee extension system within a first exterior weight pocket of a first plurality of exterior weight pockets positioned on the first lateral side of the base portion; and
placing a second base weight of the knee extension system within a first exterior weight pocket of a second plurality of exterior weight pockets position on the second lateral side of the base portion,
wherein positioning the first mounting strap and positioning the second mounting strap over the user's leg suspends the shell of the knee extension system from the user's leg beneath a posterior side of the user's knee.

17. The method of claim 16, wherein the promoting extension of the knee of the extended supported leg of the user further comprises arranging a compressible support cushion of the knee extension system on a top surface of a top portion of the shell of the knee extension system.

18. The method of claim 17, wherein the promoting extension of the knee of the extended supported leg of the user further comprises shortening a length of the first mounting strap and shortening a length of the second mounting strap such that a top side of the support cushion engages the anterior side of the user's knee, and the support cushion is partially compressed.

19. The method of claim 16, wherein the base portion of the knee extension system further comprises an inner container within an interior cavity of the base portion, and the promoting extension of a knee of an extended supported leg of a user further comprises placing at least one additional weight within the inner container.

20. The method of claim 16, wherein the promoting extension of the knee of the extended supported leg of the user further comprises:
placing a third base weight of the knee extension system within a second exterior weight pocket of the first plurality of exterior weight pockets; and
placing a fourth base weight of the knee extension system within a second exterior weight pocket of the second plurality of exterior weight pockets.
